(19) United States
(12) Patent Application Publication
(10) Pub. No.: US 2019/0080409 A1
(43) Pub. Date: Mar. 14, 2019

(54) System for Generating a Client-Action Based Modeled Market

(71) Applicants: Michael J. Burns, Riverside, IL (US); Scott F. Singer, Green Oaks, IL (US); Sagy Pundak Mintz, Austin, TX (US); William D. Campbell, SR., St. Joseph, IL (US)

(72) Inventors: Michael J. Burns, Riverside, IL (US); Scott F. Singer, Green Oaks, IL (US); Sagy Pundak Mintz, Austin, TX (US); William D. Campbell, SR., St. Joseph, IL (US)

(21) Appl. No.: 16/128,782

(22) Filed: Sep. 12, 2018

Related U.S. Application Data
(60) Provisional application No. 62/557,297, filed on Sep. 12, 2017.
(60) Provisional application No. 62/579,927, filed on Nov. 1, 2017.

(51) Int. Cl. G06Q 40/04; G06Q 30/02

(52) U.S. Cl. CPC G06Q 40/04; G06Q 30/0206; G06Q 30/0201

(57) ABSTRACT

A system for generating a client-action based modeled market is disclosed. Techniques to generate a modeled market based on client-initiated orders, while not consuming market data from an Exchange, are described herein.

An example system involves receiving client-initiated orders and subsequent actions for many clients of an ISV; managing the combined orderbook at the ISV; pre-emptively including client-initiated orders before external confirmation; combining the actions and subsequently communicated confirmations and updates into the combined orderbook; updating a modeled market engine with the updated orderbook data; preparing a modeled market based on combined orderbook data with parameterized customizations of data and logic involved in the preparation; communicating the modeled market to a feed server; optionally manipulating the modeled market data within the feed prior to sending; and communicating the modeled market data to client feed consumers.

### CROSS-REFERENCE TO RELATED APPLICATIONS

This application claims priority to U.S. Provisional Patent Application Ser. No. 62/557,297 filed on Sep. 12, 2017, and U.S. Provisional Patent Application Ser. No. 62/579,927 filed on Nov. 1, 2017, both of which are incorporated by reference herein in their entirety to the fullest extent permitted by law.

### FIELD OF INVENTION

Market participants, and other consumers of market related information, desire cost effective real-time indications of market conditions for markets of immediate interest as well as market conditions for related/informational markets.

In recent years, the cost of first-party data feeds have skyrocketed. The desire for increased revenues by exchanges has led to dramatically higher costs for consumers of exchange-provided market information.

The present invention is directed to electronic trading and market information dissemination. More specifically, the present invention is directed towards a system related to creating a modeled market feed from a consolidated set of customer order data without the need for, or benefit of, exchange disseminated market data within an electronic trading environment. An independent feed such as this can be provided by ISVs outside of the fee structure imposed by an exchange.

### BACKGROUND OF THE INVENTION

Market data for a plurality of market places becomes sent out via worldwide market data dissemination systems. A typical application for market data is to display corresponding information, for example, on a vendor terminal. Market data and additional information within market data is produced at different types of market places as, for instance, at derivatives, commodity, electronic or ECN exchanges.

Changes in technology and decentralization of data have led to significant percentages of order flow being routed through a small number of large ISVs.

These large ISVs provide their own infrastructure which is used to service the needs of many different customers. Rather than customers maintaining their own multitude of different trading devices, running exchange-provided software or APIs that were directly connected to an exchange, customers now utilize software and APIs provided by ISVs.

In these cases the ISV-provided, generalized software and APIs can be used to connect to any of the supported exchanges via the ISV infrastructure. Customers are able to use software and services, and leverage the infrastructure that the ISVs provide, without the customers having to be responsible for the upkeep. These ISV infrastructures are often replicated globally, provide access to a wide variety of global exchanges, leverage high speed connectivity, and are fully redundant and fault-tolerant.

### BRIEF DESCRIPTION OF THE DRAWINGS

Certain embodiments are disclosed with reference to, and will be better understood when read in conjunction with, the provided figures. It should be understood, however, that these are illustrative examples and that the embodiments are not limited to the arrangements shown in the attached figures.

FIG. 1 illustrates a block diagram of the overall system.

FIG. 1a illustrates a block diagram of the Aggregated OrderBook Manager

FIG. 1b illustrates a block diagram of the OrderBook Repository

FIG. 1c illustrates a block diagram of certain aspects of an Exchange.

FIG. 2 illustrates a block diagram of interactions of an exemplary version of the system

FIG. 3 illustrates a block diagram of interactions of an exemplary version of the system

FIG. 4 is a flow diagram illustrative of the Client Initiated Action Handler

FIG. 4A is a flow diagram illustrative of the Client Initiated Action Handler operating with Non-Trade Orders

FIG. 5 is a flow diagram illustrative of the Order Confirmation Handler

FIG. 6 is a flow diagram illustrative of the Order Update Handler

FIG. 7 is a flow diagram illustrative of the OrderBook Action Handler

FIG. 8 is a flow diagram illustrative of the OrderBook Confirmation Handler

FIG. 9 is a flow diagram illustrative of the OrderBook Update Handler

FIG. 10 illustrates a flow diagram of an example implementation of the component Model Engine 360 working with component Modeled Market Server 380.

FIG. 11 illustrates a flow diagram of an example implementation of the component Model Engine 360 working with component Modeled Market Server 380 towards processing of data from OrderBook Repository 140 sent via activity in Aggregated OrderBook Manager 104.

FIG. 12 illustrates a flow diagram of an example implementation of handlers of the Aggregated OrderBook Manager 104 interacting with Analytics Ledger 110.

FIG. 13 illustrates a flow diagram of an example implementation of utilizing the underlying storage of Analytics Ledger 110.

FIG. 14 illustrates a flow diagram of an example implementation of handling Non-Trade Orders and Trade orders

FIG. 15 describes an example implementation where Client 1510 does not distribute orders to Exchange 108.

### SUMMARY OF THE DISCLOSURE

In the past, order flow to an exchange originated from the many end-user sites that were directly connected to exchange endpoints and/or using exchange-provided front-end order routing screens. This arrangement ensured that only the exchange could ever aggregate information about the orders created by multiple customers.

The modern day arrangement of origination of customer orders via ISVs creates non-exchange providers where customer orders are sent, stored and directed from. Given that these non-exchange intermediaries are managing customer orders for many customers simultaneously there is a new opportunity to leverage this data in ways that previously did not exist.

An example of the value of this data is when an ISV is receiving enough customer orders that the set itself is representative of the larger market i.e., an ISV that received and managed customer orders for 25% of the total market flow would be in a good position to extract representations of the overall market from this data.

Another interesting side effect of this modern day ISV arrangement is that customers are sending their orders to the ISV with instructions on what to do with them, such as placing an order to buy something at a certain price on an exchange that matches their criteria. These customer orders are seen by the ISV in advance of any exchange, allowing the ISV to inspect and model those customer orders prior to any exchange involvement or awareness of those orders.

Given that market participants desire cost effective real-time indications of market conditions for markets of immediate interest as well as market conditions for related/informational markets, some software vendors have made initial attempts to leverage this information by creating shared order books and displaying those shared orderbooks alongside exchange-provided price and quantity market data. These solutions simply improve upon the notion of visualizing a shared orderbook aligned with price and data displays, such as is done with Trading Technologies MDTrader.

Another way the set of customer orders is leveraged is via internal-matching systems, where the ISV or trading system matches contra-side orders and reports the execution to the users, and generally to the exchange. This does not model the market, as it simply provides matching services based on commonly understood ways of matching contraside orders.

### DETAILED DESCRIPTION OF THE INVENTION

Although the following discloses embodiments that may include software executed on hardware, it should be noted that these embodiments may be implemented in other ways. It should be further noted that the embodiments disclosed herein are merely illustrative and should not be considered as limiting.

It should be noted that where a ‘copy’ operation is described that such techniques are exemplary, and that other techniques such as ‘move’ or ‘swap’ may be employed. Likewise, it should be noted that datastore elements such as Primary Versions of Order 141, Secondary Versions of Orders 142, and Pending-Delete List 143, as well as any other associated storage, could be stored together or separately, in-memory or in any appropriate file or database storage.

Additionally, it should be noted that techniques for notifying another part of the system may be referenced to as sending messages or events, however, they may be used interchangeably or other techniques such as function calls, shared memory, semaphores, Inter-Process Communication techniques, or other techniques may be used.

The present invention relates to creating and providing a modeled market feed, more particularly, to creating a modeled market feed from a consolidated set of customer order data without the benefit of exchange provided market data.

Market data in this respect consists of price, quantity, bid, ask, trade or other exchange data that the exchange provides via their real-time and historical data feeds. An example of this type of data can be found in the CME's Market Data Platform (MDP). MDP provides a real-time feed of market data messages that are sent to customers via a tagged messaging protocol consisting of market-level data, wherein that market data is distinct from messages sent to users regarding the status of any of their individual orders.

Exchanges disseminate this market data to customers and have restrictions on how an ISV or other party may redistribute that data. Additionally, significant costs are in place for usage, as well as, redistribution. In order to provide a modeled market feed that does not encounter those restrictions or costs, we propose here a system to model the market without the use of exchange provided real-time market data feeds.

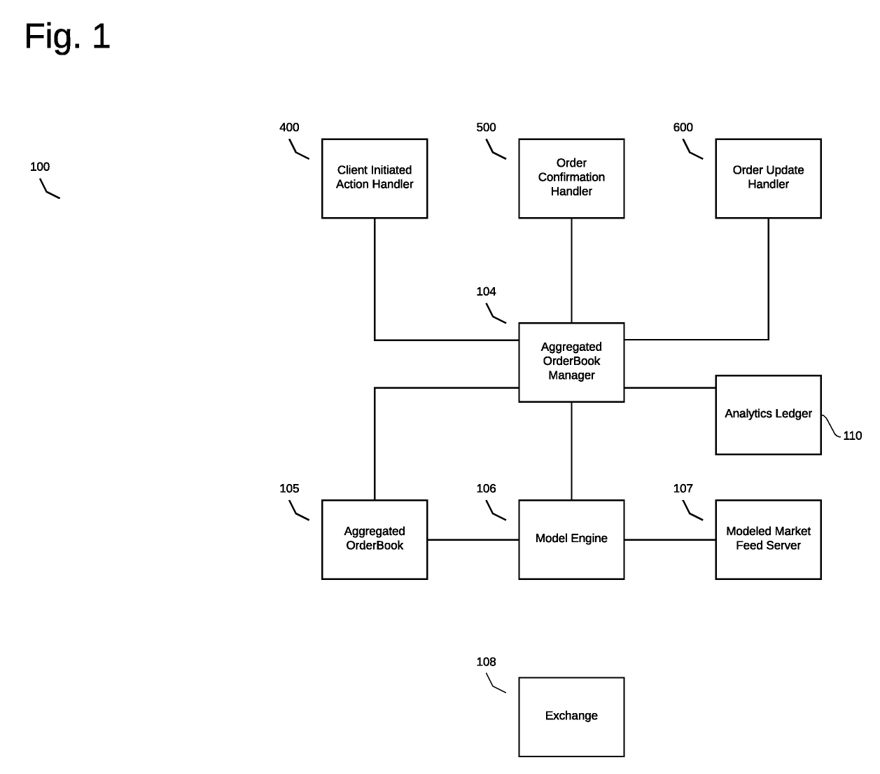

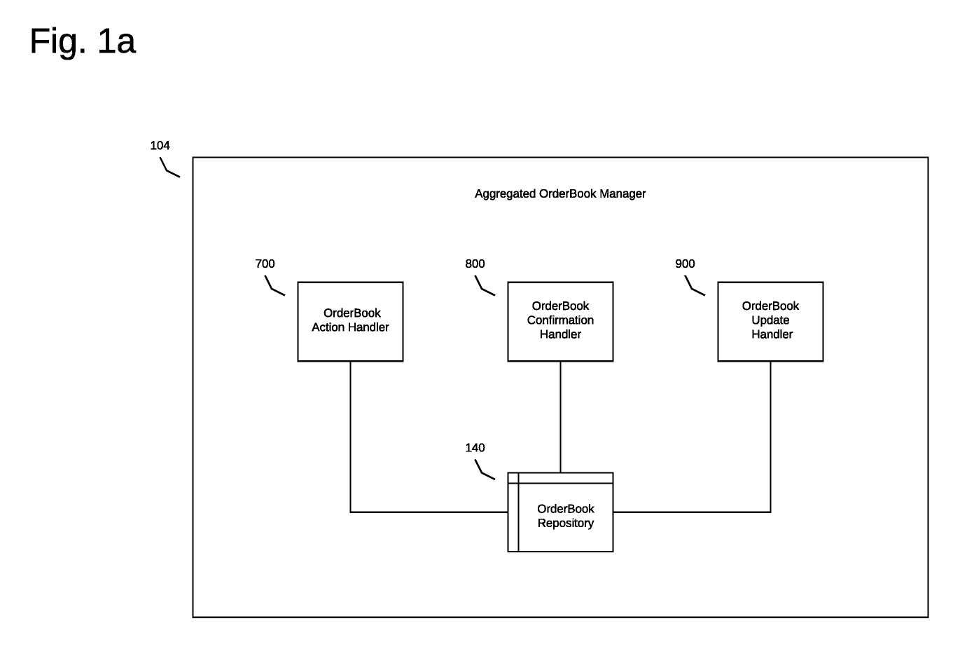

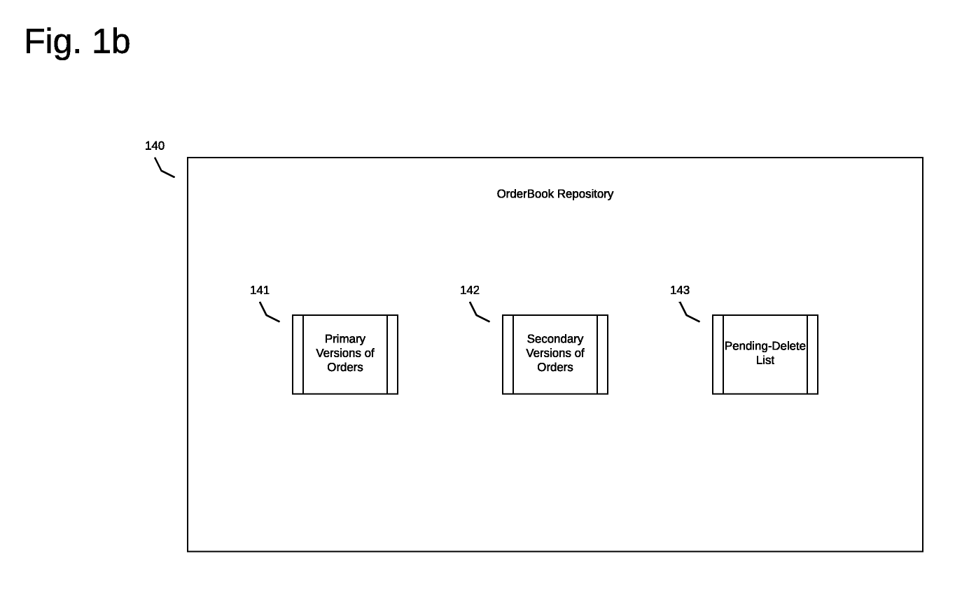

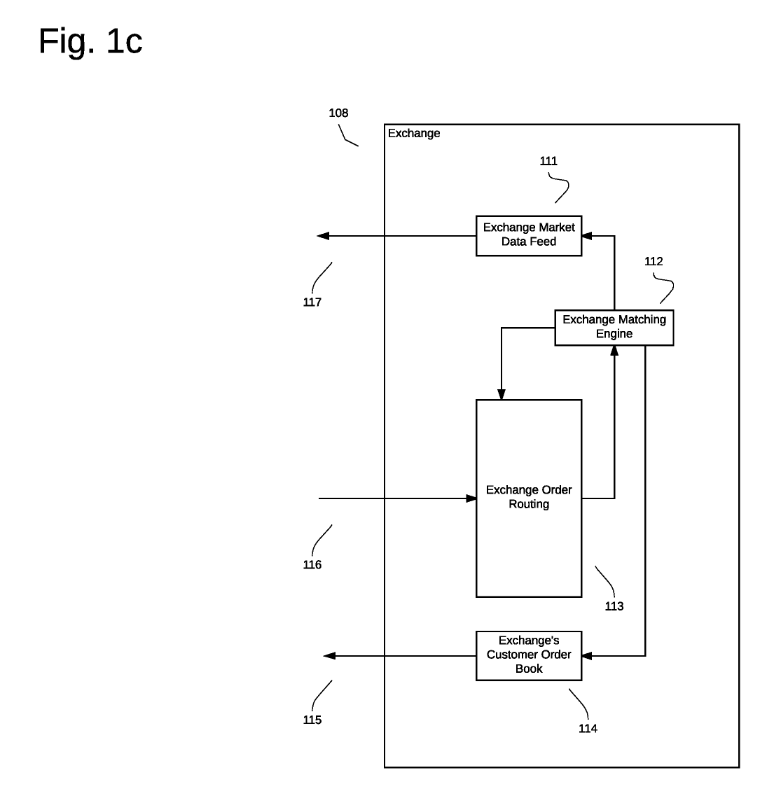

FIG. 1 illustrates a block diagram of an example system that may be used to implement the disclosed embodiment and depicts an exemplary configuration and architecture that may be implemented by the modeled market.

FIG. 1a depicts an exemplary configuration of Aggregated OrderBook Manager 104 while FIG. 1b depicts an exemplary configuration of OrderBook Repository 140. FIG. 1c depicts an exemplary configuration Exchange 108 and possible components within that may make up portions of an example architecture.

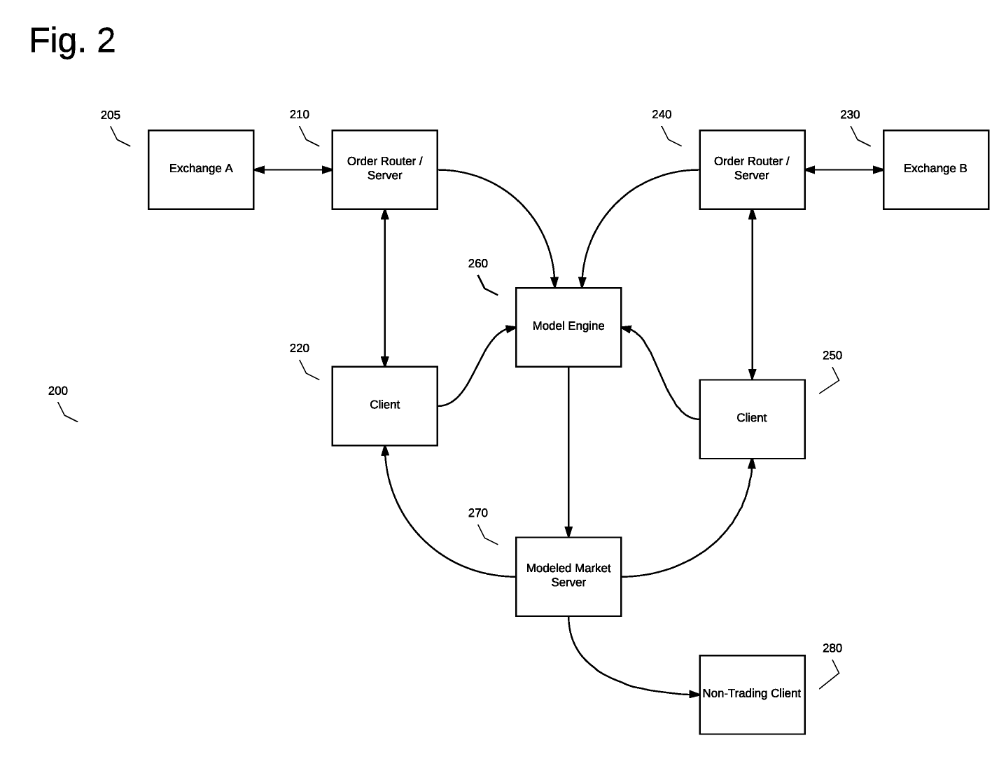

According to FIG. 2 of this disclosure, Model Engine 260 is consuming data related to client orders from Clients 220 and 250.

Updates provided by Client 220 and Client 250 include, but are not limited to, updates informing Model Engine 260 about newly created orders, cancellation of orders, as well as updates to the status of the customer order regarding partial or full fill, hold, rejection, etc.

Model Engine 260 collects updates from Client 220 and Client 250 and consolidates them into a modeled market view and passes this consolidated information on to Modeled Market Server 270, which in turn is responsible for distributing a data feed to the original Client 220 and 250, as well as to Non-Trading Client 280, which itself had no part in creating orders.

Model Engine 260 is responsible for combining the order information into a modeled view of the market using only customer order updates. Model Engine 260 may use techniques such as combining order data at similar prices and bid-ask side, removing orders from the modeled view that are contra-side and would cross, creating approximations of price levels that orders fill at, etc. Additionally or alternatively the customer order data feed into Model Engine 260 may be fed into a matching engine in order to provide a simulated market.

In this description, it is only exemplary that Model Engine 260 is provided data by Client 220 and Client 250. Any number of Client 250 may be interacted with. Additionally, communication of the Modeled Market Feed from Modeled Market Server 270 is not limited to, or required to be, exactly or only to Client 220, Client 250, or Non-Trading Client 280.

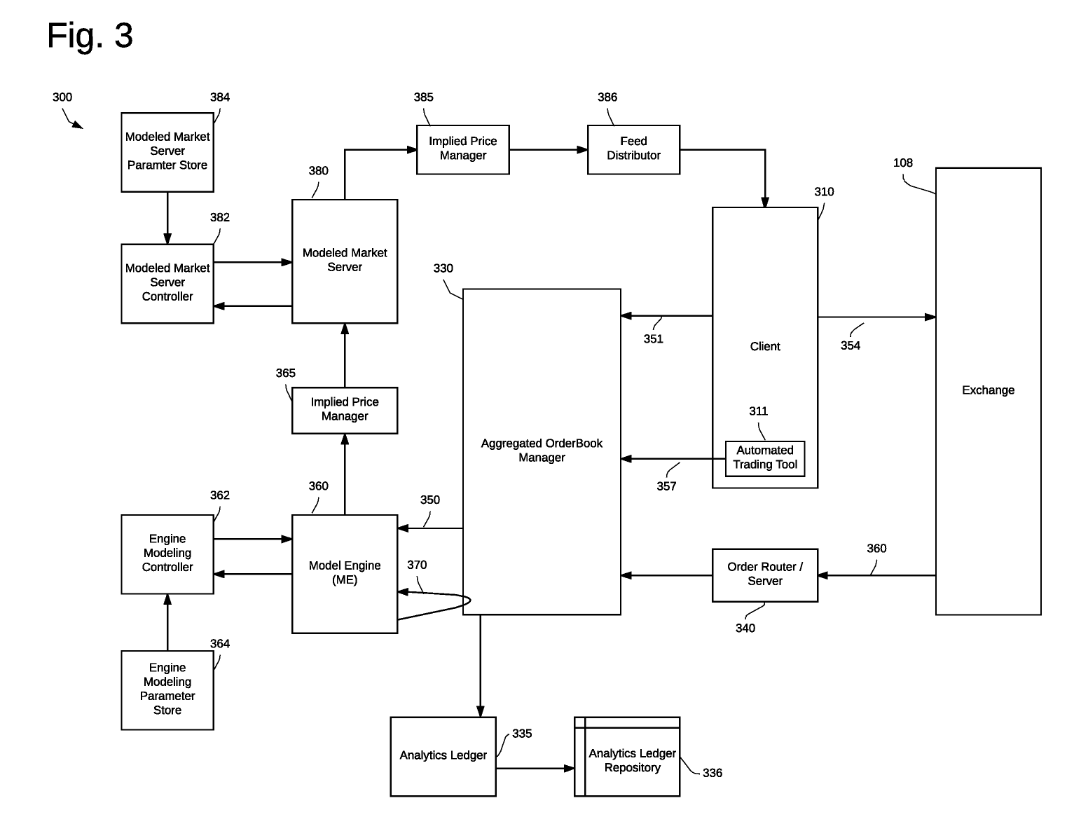

FIG. 3 describes an example implementation where Client 310 distributes order actions to the exchange as well as aggregated view of customer orders with an ISV. This might include, but is not limited to, an Aggregated Order Book (AOB) 330, which collects customer initiated order actions as well as updates from the exchange related to those orders and creates an aggregated order book representing the most up-to-date view of orders from the combined information. It is important to note that this includes notifications from Client 310 to AOB 330 when new orders are created, even in advance of Exchange 320 having received or acknowledging them.

This mechanism of providing AOB 330 orders at the time they are initiated, and potentially before Exchange 320 has even received them, may provide a speed advantage to the aggregated order book of AOB 330. Likewise, upon Order Router/Server 340 informing AOB 330 of an update to a customer order, AOB 330 may update its internal view of the aggregated order book and generate an event 350 that informs Model Engine 360 of the updated view.

The information that Client 310 sends messages to AOB 330 and Exchange 320 is related to adding, modifying and cancelling orders. Messages 351 and 354 relate to sending messages when new customer trade orders are created, modified, canceled, or otherwise updated or manipulated.

Client 310 may provide a unique identifier with every event to AOB 330 that allows for identification of the tradable object for which events are being sent. This allows Client 310 to maintain a non-changing tag when communicating to AOB 330, and allows AOB 330 to be unaware of the specifics of the tradeable object's contract details. Alternatively, AOB 330 could provide a mechanism to centralize identification of unique tradable objects, returning them to Client 310 on-demand.

Client 310 may be any device or component that prepares or sends Trade Orders, which are orders that are will be sent to Exchange 320 with the intent to be matched, as well as to AOB 330. Client 310 may contain logic or functionality that allows for Non-Trade Orders to be generated, such as in the example Automated Trading Tool 311. Non-Trade Orders differ from Trade Orders in that they are not intended to be sent to Exchange 320 and may not conform to price level increments, quantity increments, or other aspects of a Trade Order that are imposed by Exchange 320. Client 310, optionally via Automated Trading Tool 311, will generate, modify, delete, and otherwise manipulate Non-Trade Orders. These updates to Non-Trade Orders are sent to AOB 330 via message 357. It is important to note that these updates are not sent to Exchange 320. Additionally, Non-Trade Orders are tagged as Non-Trade Orders within either Client 310 or AOB 330 so that throughout the system they can be distinguished from Trade Orders.

Model Engine 360 is responsible for combining the order information into a modeled view of the market using only customer order updates. Model Engine 360 may use techniques such as combining order data at similar prices and bid-ask side, removing orders from the modeled view that are contra-side and would cross, creating approximations of price levels that orders fill at, etc. Additionally or alternatively the customer order data feed into Model Engine 360 may be fed into a matching engine in order to provide a simulated market.

The mechanisms that Model Engine 360 obtains updated views of the aggregated order book from AOB 330 include, but are not limited to, event update 350 as well as Polling Mechanism 370. When used. Polling Mechanism 370 is initiated by Model Engine 360 on a timer or other basis and will at a given interval, predetermined time, or due to another event. Polling Mechanism 370 allows Model Engine 360 to be decoupled from any events that AOB 330 itself reacts to, allowing for flexibility in how and when Model Engine 360 initiates its modeling, as well as providing systematic decoupling from events received at Order Router/Server 340 from Exchange 320 regarding orders that are known in AOB 330.

Model Engine 360 collects updates from AOB 330 and consolidates them into a modeled market view. Within FIG. 3 there are components dedicated to modifying the behavior and data analysis of the calculated modeled market and the modeled market feed. Engine Modeling Controller 362 provides a hook-based mechanism which allows for interception of update notifications and market modeling events to provide for fine tuning and adjusting of the data structures passed into Model Engine 370, as well as the data structures and calculation techniques within Model Engine 370. For example, Engine Modeling Controller 362 may manipulate the view that Model Engine 360 has on the data provided by Aggregated OrderBook Manager 330 or Aggregated Order Book 105. Engine Modeling Parameter Store 364 prevents a set of external modifiers, i.e., parameters, that are known to Engine Modeling Controller 362 and used to provide customized manipulation of the previously described manipulations of data that Model Engine 360 works with.

Modeled Market Server Controller 382 provides a similar function in that it is able to manipulate the view that Modeled Market Server 380 has on data provided from Model Engine 360, as well as providing hooks to manipulate the data that Modeled Market Server 380 outputs. An example of this may be a hook that allows for a parameterized modification of data being sent out of Modeled Market Server 380, such that the modeled market depth, or book, is adjusted via an externally set value parameter, managed via external modifiers located in Modeled Market Server Parameter Store 384, that signifies that the output be doubled, manipulated by a quantity offset, multiplied by a factor, or other adjustments.

Implied Price Manager 365 and 385 are positioned within the system to allow for optionally enabled calculation of implied prices, which would be injected into the dataset generated after Model Engine 360 or Modeled Market Server 380, respectively. This allows for flexibility as to when implied prices are calculated and added to the modeled market. This further enhances the multi-stage aspect of Model Engine 360 and Modeled Market Server 380 working together, each taking on different aspects of the final modeled market. Implied prices are typically calculated via a relationship between a composite trade object, such as one that represents a sequence of tradable objects for consecutive months traded as a single transaction, and the individual underlying tradable objects.

Implied Price Manager 365 and 385 may be configured with knowledge of these relationships, or orders provided to AOB 330 may be tagged with a mapping of what tradeable objects are related for purposes of generating implied prices.

Feed Distributor 386 provides the functionality of sending the modeled market and its updates to the set of Client 310 subscribers that are interested.

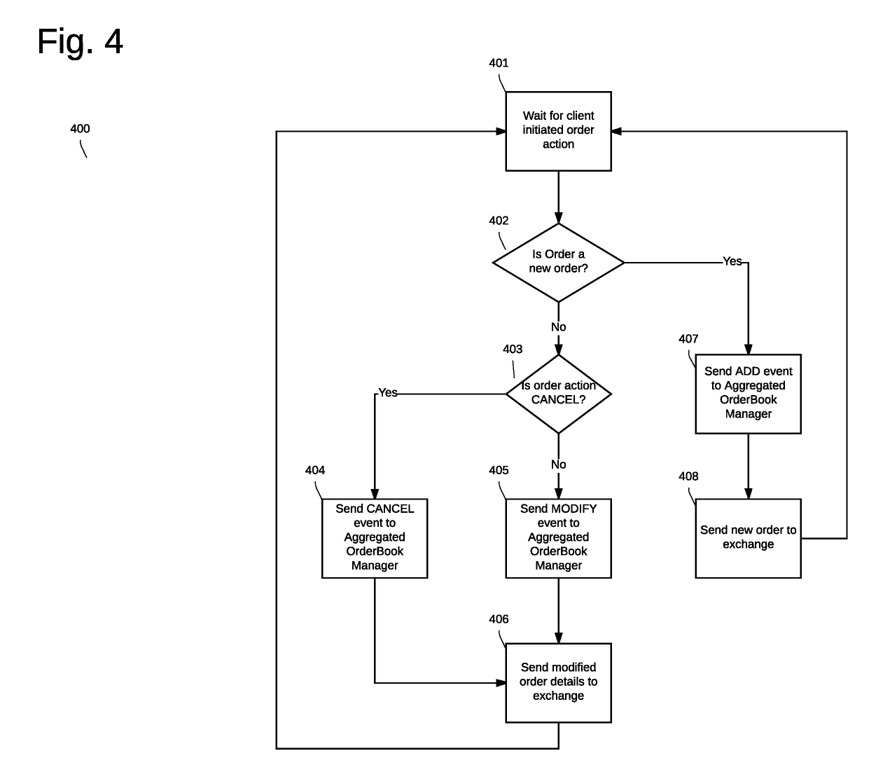

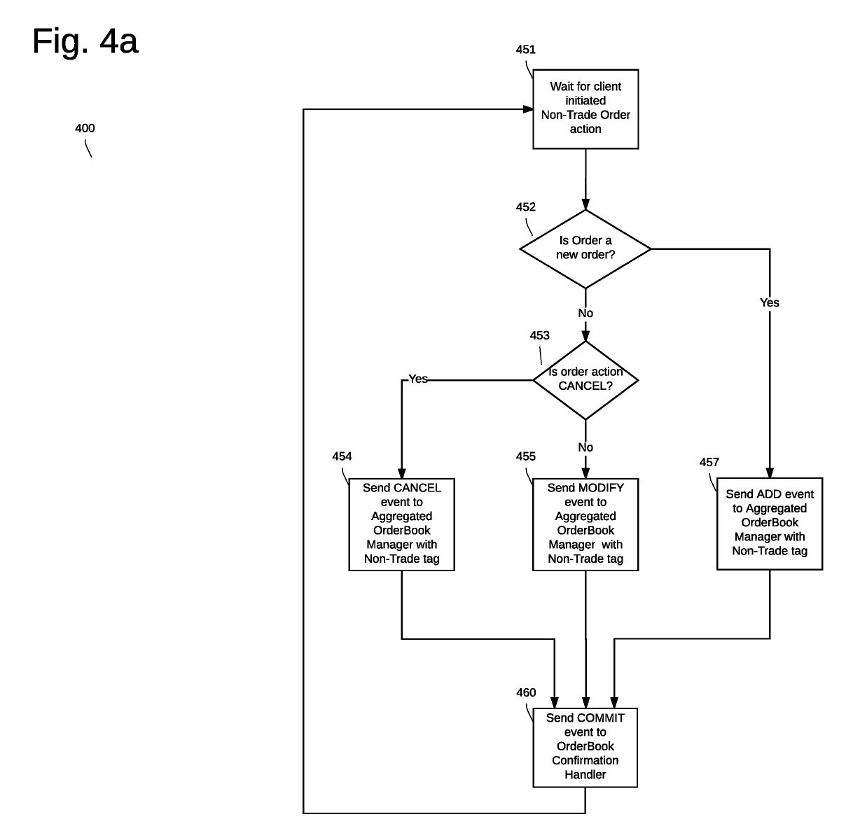

FIG. 4 illustrates a flow diagram of an example implementation of the component Client Initiated Action Handler 400. In this example, at block 401, Client Initiated Action Handler 400 is waiting for notification of order actions which have been initiated by a client trading device as a result of user action via a GUI, automated trading system. API, or other techniques.

It should be noted that AOB 330 may not be associated with an ISV. Put another way, Client 310 may communicate with AOB 330, and other components mentioned in FIG. 3, that exist outside of an ISV, such as an AOB 330 and system that is managed by a single trading group, a collective of traders, or other arrangement of cooperating entities. Such an arrangement allows a trading firm to provide the functionality of FIG. 3 on-site in a secure and private manner, or may be hosted by a cooperative of interested parties working together to generate their own custom, or private, modeled markets. Additionally it should be noted that there is no limit to the number of subsystem 300 instances described in FIG. 3, and that instances may be separated geographically.

At block 402 the incoming action, which includes or makes reference to an order, is inspected to determine if the order action represents a newly placed order or a modification to an existing order. In the case of the order action indicating a newly placed order, at block 407 an ADD message is sent to Aggregated OrderBook Manager 104. Additionally, at block 408, the request to place a new order is forwarded to Exchange 108 for submission. It should be noted that the actions taken at blocks 407 and 408 may be taken in any order, simultaneously, or otherwise intentionally delayed in their delivery.

Returning to the inspection at block 402, if the order action that has been received is for a modification to an existing order it is further inspected at block 403 to determine if the action indicates a cancellation of the order. If so, at block 404, a CANCEL event is sent to the Aggregated OrderBook Manager 104. Additionally, at block 406 the instructions to cancel the order are sent to the exchange. It should be noted that the actions taken at blocks 404 and 406 may be taken in any order, simultaneously, or otherwise intentionally delayed in their delivery.

Returning to the inspection at block 403, if the order action is a not cancel action the path indicates that the order action is to modify an existing order. At block 405 a MODIFY message is sent to Aggregated OrderBook Manager 104. Additionally, at block 406 the instructions to modify the order are sent to the exchange. It should be noted that the actions taken at blocks 405 and 406 may be taken in any order, simultaneously, or otherwise intentionally delayed in their delivery.

FIG. 4a illustrates a flow diagram of an example implementation of the component Client Initiated Action Handler 400 which is specific to handling Non-Trade Orders.

Client 310, optionally via Automated Trading Tool 311, may manage Non-Trade Orders without any externally generated order update notifications. This allows a tool like Automated Trading Tool 311 the flexibility to create, modify, and cancel Non-Trade Orders without external confirmation. An example of such behavior would be the internal establishment of a quoting order in a spread tool which is not, due to user configuration, routed to an exchange. A Non-Trade Order such as this might be created by the tool prior to sending any of the related Trade-Orders and might be cancelled when the associated automated strategy is completed.

In this example, at block 451, Client Initiated Action Handler 400 is waiting for notification of order actions which have been initiated by a client trading device as a result of user action via a GUI, automated trading system, API, or other techniques.

At block 452 the incoming action, which includes or makes reference to an order, is inspected to determine if the order action represents a newly placed order or a modification to an existing order. In the case of the order action indicating a newly placed order, at block 457 an ADD message is sent to Aggregated OrderBook Manager 104.

Returning to the inspection at block 452, if the order action that has been received is for a modification to an existing order it is further inspected at block 453 to determine if the action indicates a cancellation of the order. If so, at block 454, a CANCEL event is sent to the Aggregated OrderBook Manager 104.

Returning to the inspection at block 453, if the order action is a not cancel operation the path indicates that the order action is to modify an existing order. At block 455 a MODIFY message is sent to Aggregated OrderBook Manager 104.

Following the actions at block 454, 455, and 457 control passes to block 460 where a COMMIT message is sent to the OrderBookConfirmation Handler 500. This is representative of the recognition that the Non-Trade orders being handled in FIG. 4a are only sent to Aggregated OrderBook Manager 104, and will not have any external interaction to confirm their correctness or viability. This allows for going directly to the action of sending the COMMIT message to the OrderBook Confirmation Handler 500 without waiting for external notification. This improvement, or optimization, allows the code in OrderBook Confirmation Handler 500 to operate without having to be aware of the difference in handling of Non-Trade Orders.

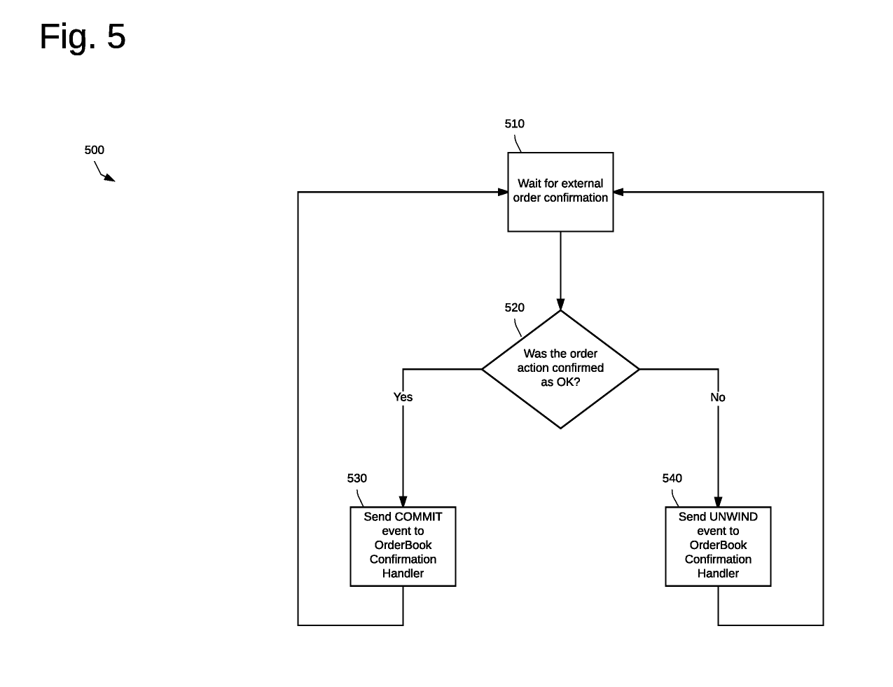

FIG. 5 illustrates a flow diagram of an example implementation of the component Order Confirmation Handler 500. In this example, at block 510 the Order Confirmation Handler 500 is waiting for confirmation of order actions which have been previously initiated by a client trading device. These confirmations may come from acknowledgement from the exchange 108, messages from other trading system components such as a drop-copy feed, or any other source of confirmation that the trading system may integrate with. Alternatively, the system may allow for user-specified confirmation of previously initiated orders.

At block 520 the incoming message is inspected to determine if the order action was confirmed as successful or OK. If the action was confirmed as OK, at block 530 a COMMIT message is sent to Aggregated OrderBook Manager 104

Returning to the inspection at block 405, if it was determined that the order action was not confirmed as successful, an UNWIND message is sent to Aggregated OrderBook Manager 104 to inform it that the previously attempted action did not succeed. While this failure may have been due to Exchange 108 having rejected the order action, it may also have come from some other error associated with transmitting or communicating the order.

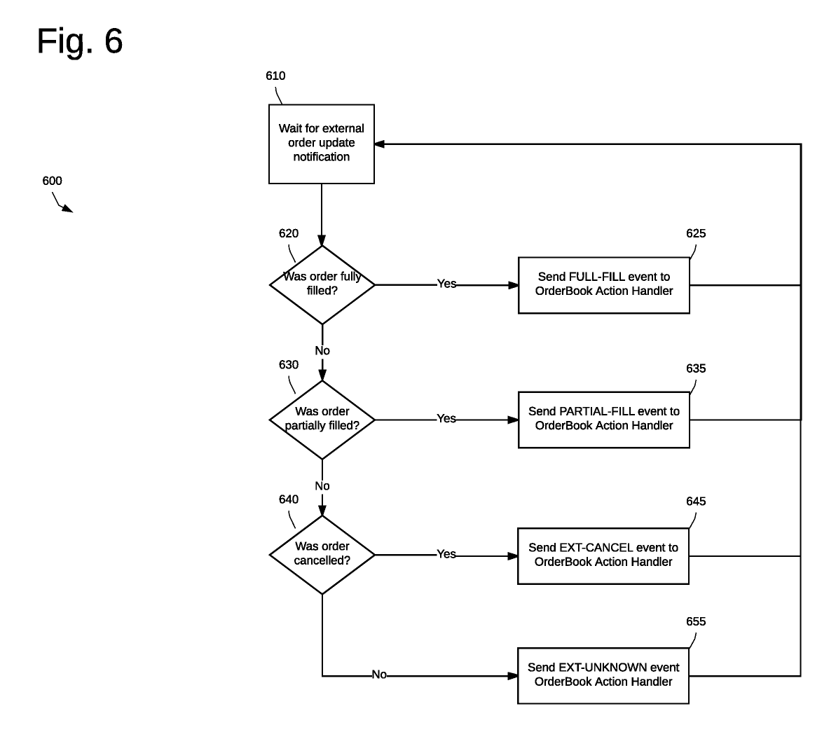

FIG. 6 illustrates a flow diagram of an example implementation of the component Order Update Handler 600. In this example, at block 510 the Order Update Handler 600 is waiting for updates to orders which have been previously initiated by a client trading device. These updates may originate externally from the system, such as from exchange 108, messages from other trading system components such as a drop-copy feed, or any other source of confirmation that the trading system may integrate with. Alternatively, the system may allow for user-specified updates of previously initiated orders. Updates that may occur include fills, partial-fills, or cancellation. These updates reflect events that have occurred, leading to a change in state of the customer-initiated orders.

At block 610 the system is waiting for notification of an external order update message or event.

At block 620 the system inspects the incoming message to see if it indicates a full-fill event on the user's order. In this case a FULL-FILL event is sent to the Aggregated OrderBook Manager 104.

If the message did not indicate a full-fill the system further inspects the incoming message at block 630 to see if it indicates a partial-fill event on the user's order. In this case a PARTIAL-FILL event is sent to the Aggregated OrderBook Manager 104.

If the message did not indicate a full-fill or a partial-fill, at block 640 the system inspects the incoming message to see if it indicates an external cancellation of the user's order has been initiated. If this is detected, an EXT-CANCEL message is sent to Aggregated OrderBook Manager 104.

Finally, in this example embodiment, when an unexpected, or error, message is detected at block 655 the system will send an EXT-UNKNOWN message to Aggregated OrderBook Manager 104.

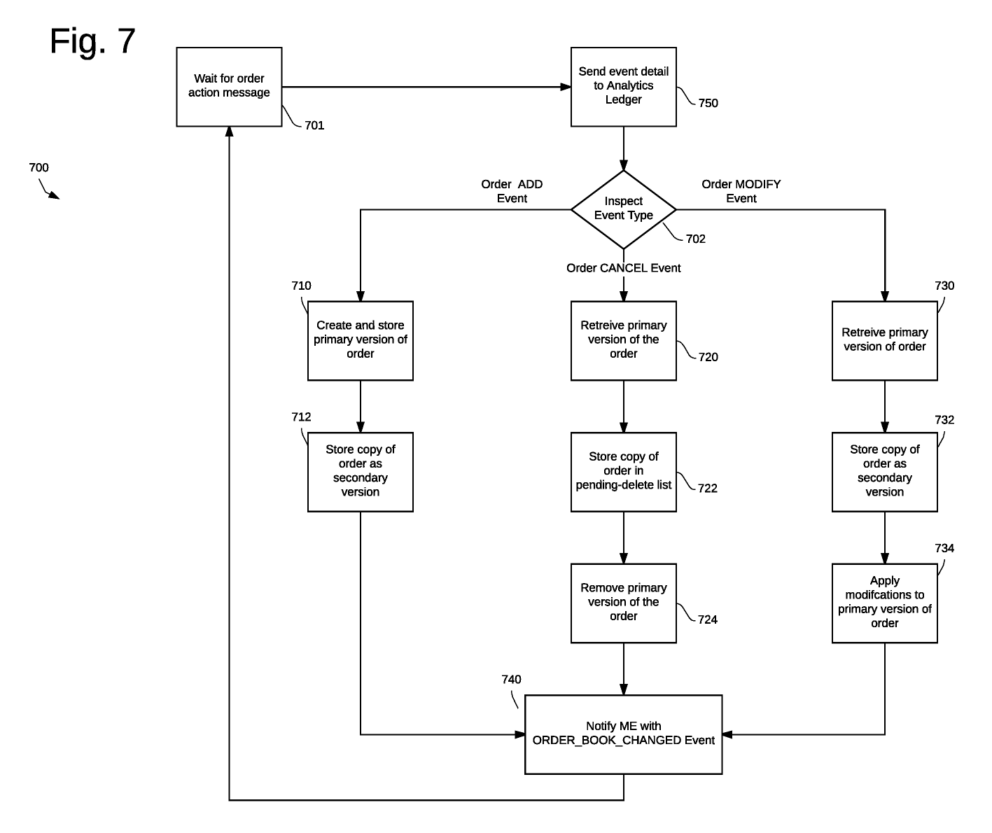

FIG. 7 illustrates a flow diagram of an example implementation of the component OrderBook Action Handler 700, which is part of or associated with Aggregated OrderBook Manager 104. In this example, at block 701 the system is waiting for messages related to order actions that are applicable to the Aggregated OrderBook Manager 104. When a message is received, at block 750 the details of the action are sent to Analytics Ledger 110, and the event is inspected at block 702 to determine it's type.

If an ADD message is detected at block 702 the system takes action to add a new order to the storage associated with Aggregated OrderBook Manager 104, which in this exemplary implementation is associated with OrderBook Repository 140. To accomplish the handling of the new order and storing the appropriate details, at block 710 the system will create and store a primary version of the order. The primary order is intended to represent the version of an order that is seen as being contained within the current Aggregated OrderBook Manager 104 view of the overall, aggregated, view of orders. Additionally, the primary version of the order is meant to be the version of the order that is included when Model Engine 106 is evaluating the current set of orders in the aggregated orderbook. Furthermore, storage of primary versions of orders within Aggregated OrderBook Manager 104 is located in the datastore Primary Versions of Orders 141.

At block 712 the system also makes a copy of the order and stores it as a secondary version of the order, located in the data store Secondary Versions of Orders 142 within the Aggregated OrderBook Manager 104. Following that, at block 740, the system notifies Model Engine 106 that the new order has been added by sending an ORDER_BOOK_CHANGED event to Model Engine 106.

It should be noted that the purpose of storing primary and secondary orders is to allow for the immediate inclusion of new orders into the view represented by the aggregated orderbook while preserving the ability to easily identify and remove orders that may not have been successfully submitted to Exchange 108 due to communication errors, malformed data, bad market conditions, or other issues. The model represented by OrderBook Repository 140 allows the system to immediately integrate new orders and subsequent user-initiated actions on those orders at the time of user-initiated action. This provides a model of assuming success and provides a mechanism that allows Model Engine 106 to model markets based on these actions in a speed-advantageous manner. This may allow the output via Modeled Market Feed Server 107 to arrive to consumers of the feed prior to those consumers receiving data from the Exchange Market Data Feed 111.

Returning to the decision point at block 702, if a CANCEL message is detected at block 702, the logic flow goes to block 720 where the previously stored primary version of the order is retrieved from datastore 141. At block 722 a copy is made of the retrieved order and placed in Pending-Delete List 143. The storage at 143 represents copies of orders that are pending delete such that it can easily be detected if an order is pending-delete. Subsequently, at block 724 the primary version of the order is removed from datastore 141. Following that, at block 740, the system notifies Model Engine 106 that the new order has been added by sending an ORDER_BOOK_CHANGED event to Model Engine 106.

Returning to the decision point at block 702, if a MODIFY message is detected at block 702, the logic flow goes to block 730 where the previously stored primary version of the order is retrieved from datastore 141. At block 732 a copy is made of the retrieved order and stored as the secondary version of the order in datastore 142. The storage of the secondary order in datastore 142 represents a backup copy of the orders that are pending a change such that it can easily be restored if the pending change is not ultimately successful. Subsequently, at block 734 the primary version of the order is updated in datastore 141 to include the pending changes. Following that, at block 740, the system notifies Model Engine 106 that the new order has been added by sending an ORDER_BOOK_CHANGED event to Model Engine 106.

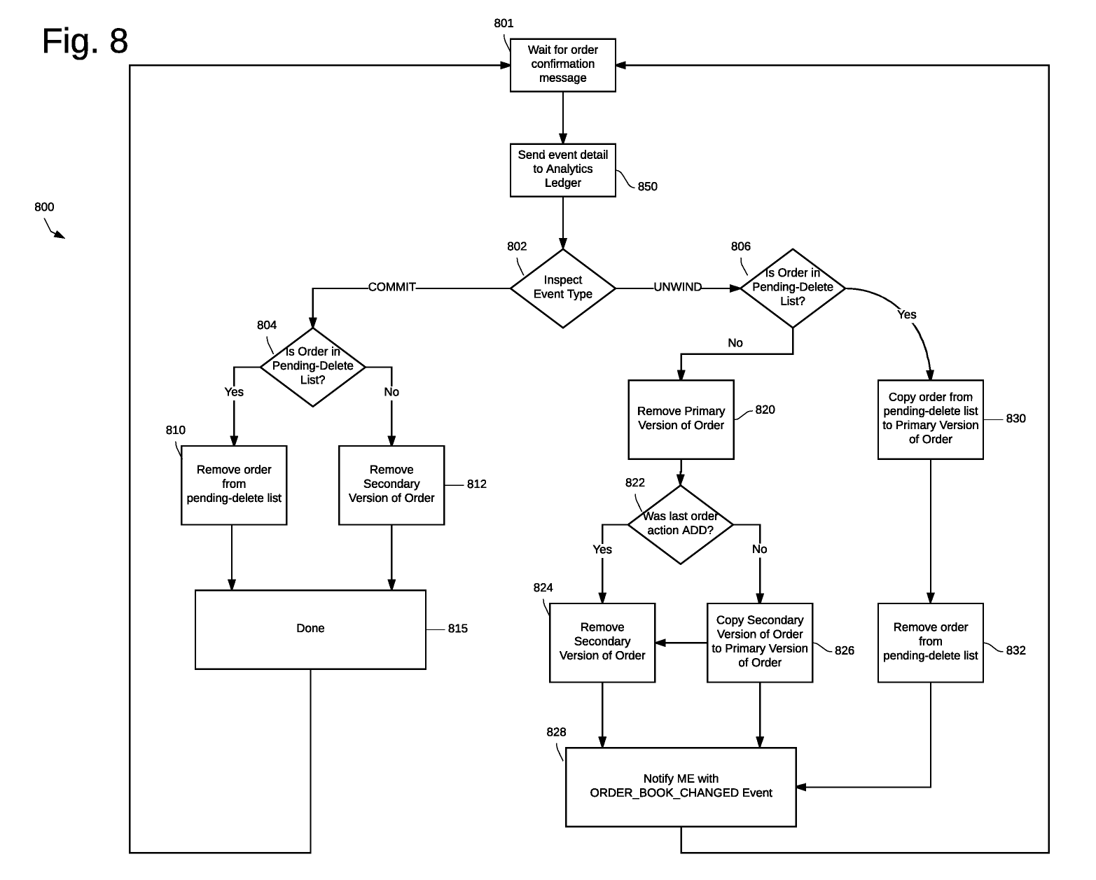

FIG. 8 illustrates a flow diagram of an example implementation of the component OrderBook Confirmation Handler 800, which is part of or associated with Aggregated OrderBook Manager 104. In this example, at block 801 the system is waiting for messages related to confirmations of order actions that are applicable to the Aggregated OrderBook Manager 104.

When a message is received, at block 850 the details of the action are sent to Analytics Ledger 110, and the event is inspected at block 802 to determine it's type. If the system detects that the message type is COMMIT it reflects the confirmation message as indicating that a pending action has succeeded. In this case, at block 804 the system looks up the order associated with the COMMIT message and determines if the order is present in Pending-Delete List 143. If it is, at block 810 the order, which was previously inserted into Pending-Delete List 143 back in block 722, is removed from Pending-Delete List 143. No additional action is needed at this time as the associated primary version of the order has already been removed from storage Primary Versions of Orders 141 at block 724. These steps, when the message is COMMIT, effectively allow the actions made in 700 to be finalized.

Returning back to block 804, if the order was not present in Pending-Delete List 143 the system removes the secondary version of the order at block 812 by removing it from Secondary Versions of Orders 142. No additional action is needed at this time as the associated primary version of the order has already been created or updated in storage Primary Versions of Orders 141 during block 710 or 734, respectively. These steps, when the message is COMMIT, effectively allow the actions made in 700 to be finalized.

Returning back to decision block 802, if the type of the order confirmation message is UNWIND the system needs to restore the prior version of the order. At block 806 the system looks up the order associated with the UNWIND message and determines if the order is present in Pending-Delete List 143. If it is, at block 830 a copy of the order associated with the message in Pending-Delete List 143 is made and placed into the datastore Primary Versions of Orders 141, followed by removal of the order associated with the message from Pending-Delete List 143. Following that, an ORDER_BOOK_CHANGED message is sent to Model Engine 106. This allows the data in OrderBook Repository 140 to reflect a state of the data which includes the related order in its restored state.

Returning back to decision block 806, if the order associated with the message was not present in Pending-Delete List 143 control passes to block 820 where the system retrieves the primary version of the associated order and inspects it in block 822 to determine if the last order action associated with the order was ADD.

If so, at block 824 the secondary version of the order is removed from Secondary Versions of Orders 142. At this point the system has removed both the primary version of the order and the secondary version of the associated order during blocks 820 and 824 respectively. The order is no longer present in OrderBook Repository 140 due to the failure to ADD and subsequent UNWIND. As such, following that, an ORDER_BOOK_CHANGED message is sent to Model Engine 106. This allows the data in OrderBook Repository 140 to reflect a state of the data which no longer includes the related order.

Returning to block 822, the last order action was not ADD, so control passes to block 826 where a copy of the secondary version of the order is obtained from Secondary Version of Orders 142 and is used to overwrite the primary version of the order in Primary Version of Orders 141. This allows the system to restore the state of the primary version of the order to that before the unsuccessful modification attempt. As the secondary copy of the order is no longer needed (as there is no longer a pending operation) control passes to block 824 where the associated order in Secondary Versions of Orders 142 is removed.

Following that, an ORDER_BOOK_CHANGED message is sent to Model Engine 106. This allows the data in OrderBook Repository 140 to reflect a state of the data which no longer includes the related order.

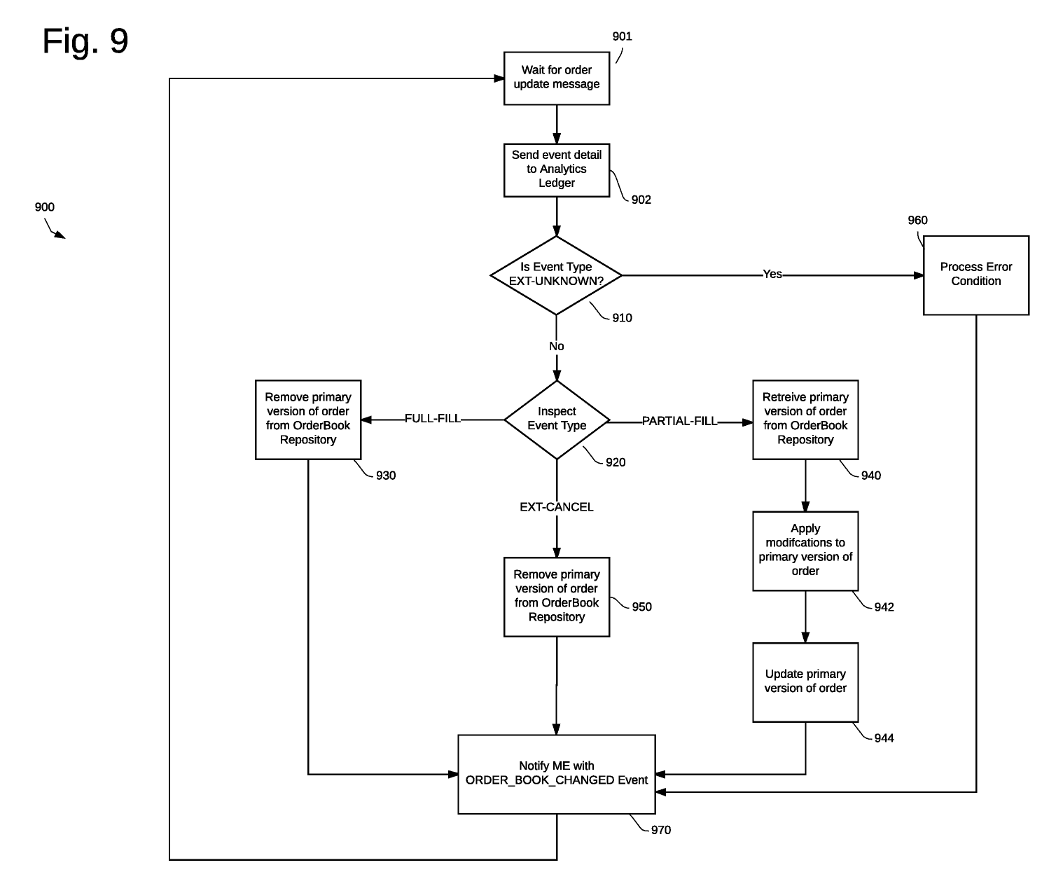

FIG. 9 illustrates a flow diagram of an example implementation of the component OrderBook Update Handler 900, which is part of or associated with Aggregated OrderBook Manager 104. In this example, at block 901 the system is waiting for messages related to updates of orders which may have been previously initiated by a client trading device, and are represented within OrderBook Repository 140.

When a message is received, at block 902 the details of the action are sent to Analytics Ledger 110. At block 910 the system inspects the event type to see if it is EXT-UNKNOWN. If the event type is indeed EXT-UNKNOWN, at block 960 the system processes the error condition in an appropriate way, such as log messages, user notification, GUI display, system-level messages, or other appropriate responses. This may include modifying or removing data within OrderBook Repository 140. The system then, at block 970, notifies Model Engine 106 that data may have changed by sending the ORDER_BOOK_CHANGED message.

Returning to block 910, when it is determined that the event type is known, it is further inspected at block 920 to determine if the event indicates that the order associated with the event has been fully filled. This is an indication that the order is no longer considered to be working in the market and has been fully matched. Given this knowledge, the order no longer needs to appear in the data of OrderBook Repository 140. Accordingly, at block 930 the primary version of the order is removed from datastore Primary Versions of Orders 140. The system then, at block 970, notifies Model Engine 106 that data may have changed by sending the ORDER_BOOK_CHANGED message.

Returning to block 920, where it has been determined that the event indicates that the order associated with the event has been partially filled, due to the event type indicating PARTIAL-FILL. This is an indication that the order quantity which is considered to be working in the market has been reduced due to a portion of it having been matched. Given this knowledge, the order quantity associated with the data for this order in OrderBook Repository 140 must be updated. Accordingly, at block 940 the primary version of the order is retrieved from datastore Primary Versions of Orders 140. At block 942 the primary version of the order is modified such that the quantity indicated to be working, or present, in the market at Exchange 108 reflects the partial fill reported in the event. Following that, at block 944, the primary version of the order is updated in datastore Primary Version of Orders 141. The system then, at block 970, notifies Model Engine 106 that data may have changed by sending the ORDER_BOOK_CHANGED message.

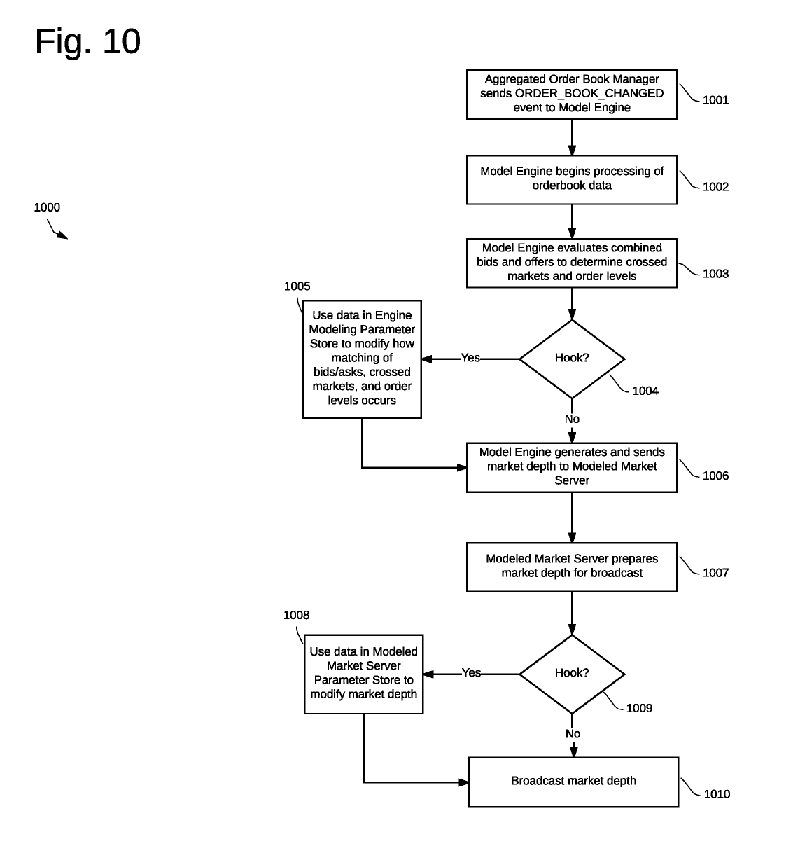

FIG. 10 illustrates a flow diagram of an example implementation of the component Model Engine 360 working with component Modeled Market Server 380 towards processing of data from OrderBook Repository 140 sent via Aggregated OrderBook Manager 104. FIG. 10 focuses on the activities of Model Engine 360 related to the processing of order book data and creating a representation of market depth based on this, as well as broadcasting a feed based on this data.

The exemplary steps of FIG. 10 describe ‘hooks’ to the process of modeling market data such that they allow manager components to hook into the data and/or process flow and manipulate the calculations, transformations, and/or data. Accordingly, along with the manager component a “parameter store” component provides storage and external interfacing for the values used in these parameterized manipulations.

In this example, at block 1001 the system is waiting for messages related to changes in the data managed by Aggregated OrderBook Manager 104, such as the ORDER_BOOK_CHANGED event. When this event is received, Model Engine 106 directs control to blocks 1002 and 1003 where, for example, processing of the data may include combining of client initiated bids and offers, determining where bids and offers match or cross, determining market depth price levels and quantities, or other processing needed to model the given market and the associated order levels (or market depth).

If it is determined during this processing that a hook is present, such as at decision block 1004, the system directs processing to a component such as Engine Modeling Controller 362.

At block 1005 the system utilizes parameters stored in Engine Modeling Parameter Store 364 to make modifications to the data or logic being used to generate the output of Model Engine 360. Examples of this include parameters to increase or decrease the quantities of bids and offers by an absolute, relative, or scaling value; application of a parameter to manipulate the quantity values of the best bid or best offer (inside market); insertion or deletion of all or part of order quantity at a parameterized price level; or other transformations based on parameterized values stored in Engine Modeling Parameter Store 364. Additionally, Engine Modeling Controller 362 may direct changes to the logic of how orders are matched or combined.

Regardless of the presence of a hook at block 1004, system flow returns to block 1006, where Model Engine 360 generates or assembles output data and sends it to Modeled Market Server 380.

Within the processing of Modeled Market Server 380 the received data is prepared for broadcast to client consumers. Similar to 1004, execution continues to the hook decision point 1009 to determine if processing should be directed to Modeled Market Server Controller 382 in block 1008 due to the presence of a hook.

If a hook was present, at block 1008 the system utilizes parameters stored in Modeled Market Server Parameter Store 384 to make modifications to the data or logic being used to generate the output of Modeled Market Server 380. Examples of this include parameters to increase or decrease the quantities of bids and offers by an absolute, relative, or scaling value; application of a parameter to manipulate the quantity values of the best bid or best offer (inside market); insertion or deletion of all or part of order quantity at a parameterized price level; or other transformations based on parameterized values stored in Modeled Market Server Parameter Store 384.

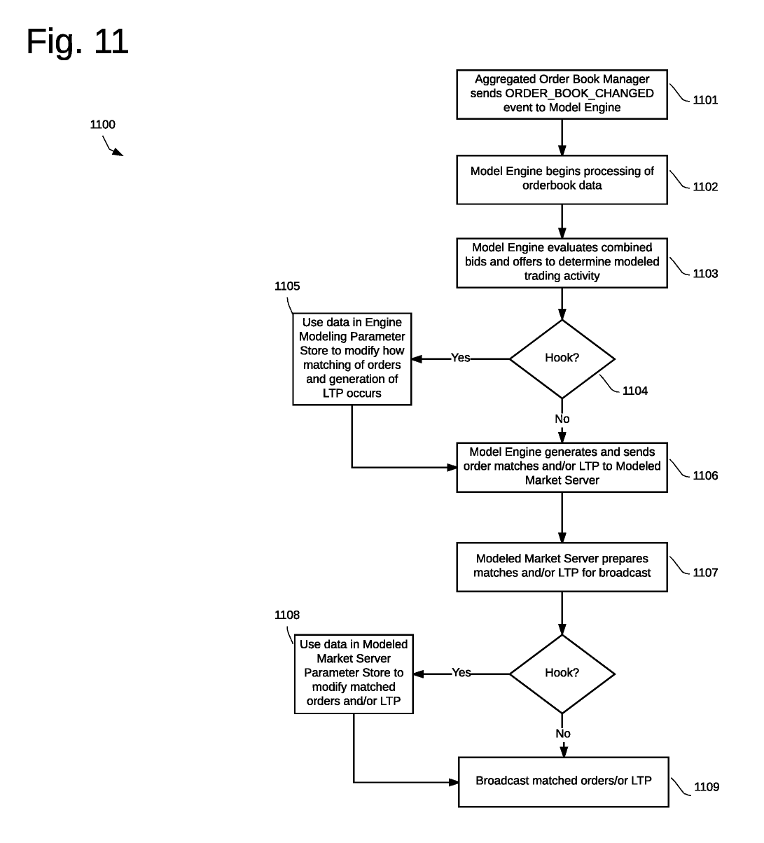

FIG. 11 illustrates a flow diagram of an example implementation of the component Model Engine 360 working with component Modeled Market Server 380 towards processing of data from OrderBook Repository 140 sent via Aggregated OrderBook Manager 104. FIG. 11 focuses on the activities of Model Engine 360 related to the processing of order book data and creating a representation of modeled matches, otherwise known as fills, and last traded price (LTP) based on those matches, as well as broadcasting a feed based on this data.

Other metrics of the modeled market related to modeling of order matches may also be calculated, assembled, created or manipulated. While the examples listed here include LTP, other aspects of a modeled market may be calculated, including, but not limited to, modeling of last traded quantity, quantity traded in a session or time period, traded quantity per-price level, and others.

The exemplary steps of FIG. 11 describe ‘hooks’ to the process of modeling market data such that they allow manager components to hook into the data and/or process flow and manipulate the calculations, transformations, and/or data. Accordingly, along with the manager component a “parameter store” component provides storage and external interfacing for the values used in these parameterized manipulations.

In this example, at block 1101 the system is waiting for messages related to changes in the data managed by Aggregated OrderBook Manager 104, such as the ORDER_BOOK_CHANGED event. When this event is received, Model Engine 106 processes the data in block 1102, for example, including the combining of client initiated bids and offers, determining where bids and offers match or cross, determining market depth price levels and quantities, and other processing needed to model the given market.

At block 1103 Model Engine 360 evaluates combined bids and offers to determine modeled trading activity such as LTP.

If it is determined during this processing that a hook is present at decision block 1104, the system directs processing to a component such as Modeled Market Server Controller 382.

At block 1105 the system utilizes parameters stored in Engine Modeling Parameter Store 364 to make modifications to the data or logic being used to generate the output of Model Engine 360.

Examples of this include parameters to increase or decrease the quantities of bids and offers by an absolute, relative, or scaling value; application of a parameter to manipulate the quantity values of the best bid or best offer (inside market); insertion or deletion of all or part of order quantity at a parameterized price level; or other transformations based on parameterized values stored in Engine Modeling Parameter Store 364. Additionally, Engine Modeling Controller 362 may direct changes to the logic of how orders are matched or combined, or may direct changes as to how LTP or other modeled metrics are calculated.

Regardless of the presence of a hook at block 1104, system flow returns to block 1106, where Model Engine 360 generates or assembles output data related to trading activity and sends it to Modeled Market Server 380.

Within the processing of Modeled Market Server 380 the received data is prepared for broadcast to client consumers. Similar to 1104, execution continues to the hook decision point 1109 to determine if processing should be directed to Modeled Market Server Controller 382 in block 1108 due to the presence of a hook.

If a hook was present, at block 1108 the system utilizes parameters stored in Modeled Market Server Parameter Store 384 to make modifications to the data or logic being used to generate the output of Modeled Market Server 380. Examples of this include parameters to increase or decrease the quantity of LTP or other modeled metrics: application of a parameter to override the quantity values; insertion of additional modeled metrics; deletion of all or some of the modeled metrics; or other transformations based on parameterized values stored in Modeled Market Server Parameter Store 384.

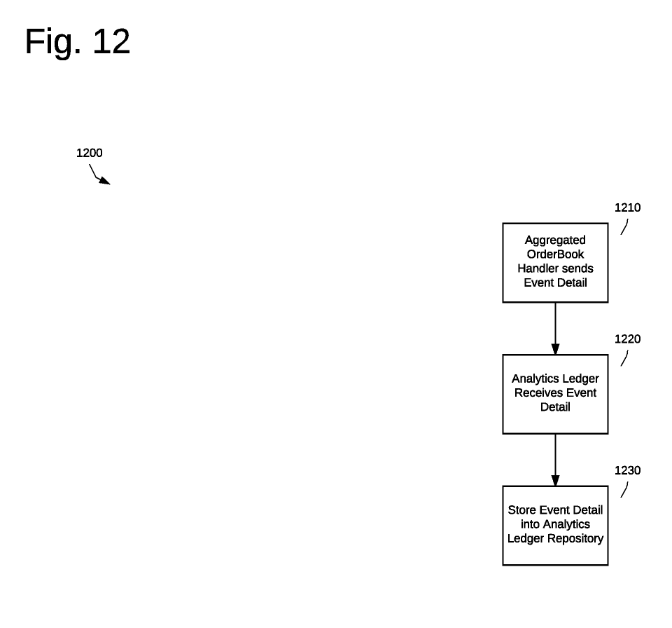

FIG. 12 illustrates a flow diagram of an example implementation of handlers of the Aggregated Orderbook Manager 104 interacting with Analytics Ledger 110. When receiving action notifications or messages, components OrderBook Action Handler 700, OrderBook Confirmation Handler 800, and OrderBook Update Handler 900 may, for example, cause the details of those notifications of messages to be stored into Analytics Ledger 110.

The exemplary steps of FIG. 12 describe this functionality in context of how it fits into FIGS. 7, 8 and 9, in blocks 750, 850, and 902, respectively. When sending event detail to Analytics Ledger 110, the detail may include Uniquely Identifying Information (UII) such as the name or ID of the trader or firm, geographical location, type of trading software, or other items of information that may be used to uniquely identify a demographic related to the order.

At block 1210, a handler sends details about the order related event, along with associated UII, to Analytics Ledger 110. Upon receipt of this information, at block 1220 Analytics Ledger 110 stores the information into Analytics Ledger Repository 336.

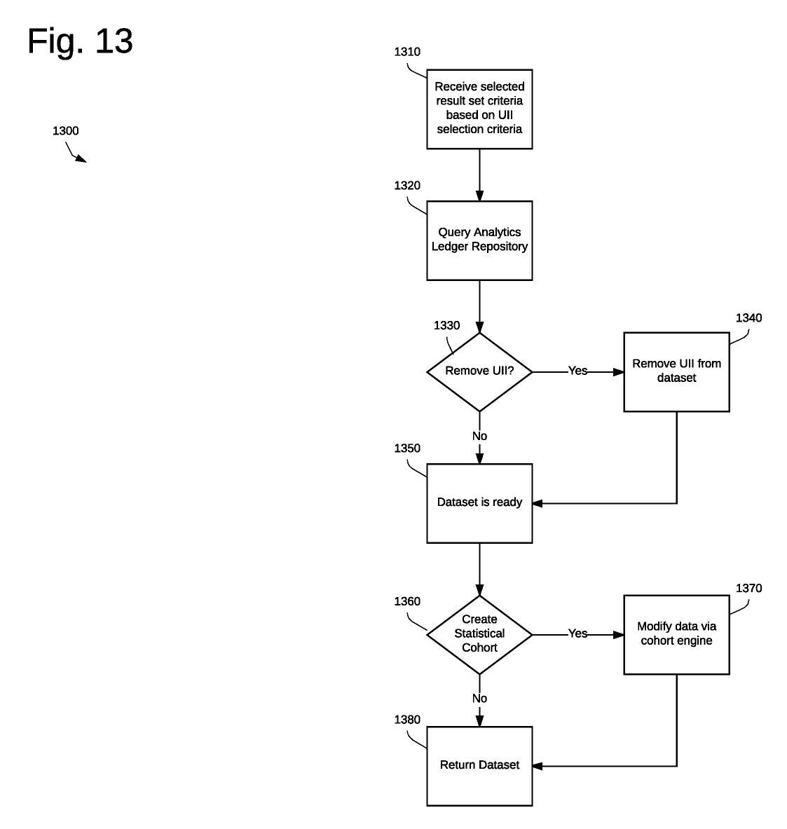

FIG. 13 illustrates a flow diagram of an example implementation of utilizing the underlying storage of Analytics Ledger 110, such as Analytics Ledger Repository 336. Because market participants may desire to keep their UII private, and not disclosed to other participants, Analytics Ledger 110 allows for retrieval of historical data from Analytics Ledger Repository 336 in such a way that allows for the removal of UII when the data is returned from historical data queries, while allowing for the query request to include context that may include UII.

Turning to block 1310, Analytics Ledger 110 allows for a request for data retrieval with a set of criteria that may contain not only parameters such as date, time, tradable object, or side-of-market, but also parameters that may be considered UII. The UII parameters may include, for example, geographical location, trading software vendor, trading software version, connectivity method, user name, or other data that may have identifying aspects.

At block 1320 a request is made to Analytics Ledger Repository 336 with the full scope of data, including UII parameter data, available to be used to narrow the scope of the request. At block 1330 the optional decision is made to remove UII. Removal of UII may be based on system configuration or settings, or may be initiated by evaluating the dataset thus far returned. For the latter approach, the data returned from the request may include fields that indicate, for each row or subset of data, if the originator of the data required that UII be removed, or which types of UII may be made visible to parties other than the originator.

Block 1340 is reached if UII must be removed. Removing UII may, depending on configuration or options, include removal of columns or substitution of data. For example, if username is a field required to be removed for all data returned, the entire column of data may be removed. Alternatively, if the data is stored in structures other than rows and columns, fields of classes or structures may be dynamically removed or hidden. Alternatively, all instances of UII that must be removed may be blanked out or replaced with a predefined moniker.

Returning to block 1350, the dataset no longer contains UII and control may move to block 1360 where a statistical cohort, or other form of statistic based grouping, may be generated. At block 1370 a cohort is created and may be anonymized such that the remaining data is manipulated to provide a set of data that is statistically similar to, but lacks any UII of, the original data. This may be useful when providing results for a request originally narrowed by UII parameters such that the resulting data is not capable of revealing unwanted information. Such an approach allows for the identification of data trends without revealing the actual underlying data values by replacing data fields with statistically consistent, but different, values.

Finally, control continues at block 1380, where the resulting dataset is returned.

Non-Trade Orders

In some automated trading tools there exist conditions where the trading tool may be able to calculate an order that could be sent, or routed, to an exchange, but is not. Due to the fact that these orders are not sent to the exchange they cannot be considered to be Trade Orders, as they will not become working orders. Orders like these, that are not sent to the exchange, can be considered Non-Trade Orders.

Orders that are sent to the exchange are considered Trade Orders. A Trade Order may be prepared in such a way that the underlying, ideal, calculated price does not conform to exchange defined price levels, tick increments, or other exchange required parameter alignments. When sending a Trade Order like this to the exchange it is necessary to change the price level, or other parameters, such that it is rounded to, or snapped to, an exchange defined price increment, or tick. This is necessary for the exchange to accept the order, even though a more finely tuned, or ideal, price level had been calculated.

Trade Orders that are sent to the exchange may include data which includes the underlying ideally calculated price, which can be considered the ideal price. Non-Trade Orders are draft, or ideal, orders that are not sent to, or known by, the exchange. They are, however, actively updated by the client or automated tool such that they represent a potential order that, other than for the fact that they are not sent to the exchange, are fully qualified orders. The use of Non-Trade orders within a client or automated tool allows for the tool to manage orders that would, could, or might be sent to the market.

Due to the fact that they are not known by the exchange, Non-Trade Orders may not be subject to certain exchange rules that otherwise apply to Trade Order. This may include limitations on price level, frequency of requoting, or other order parameters. For example, an automated trading tool may re-calculate the ideal price of a Non-Trade Order on a more frequent basis than would be accepted by the exchange if the order modifications were being sent to the exchange, or for a price level that is not on an exchange defined price boundary.

Non-Trade Orders that are not shared outside of the internal calculations of a client or an automated trading tool do not become part of the exchange's market data. The current invention provides for Non-Trade Orders to be known to the system and included in the modeled data that is produced.

It should be noted that unlike current state of the art order books, the Aggregated Orderbook Manager 104 is not limited to accepting and managing only orders that are known to the market. Put another way, Aggregated Orderbook Manager 104 accepts and manages both Trade Orders and Non-Trade Orders. This includes the ability to accept and manage orders that do not fall onto exchange defined price levels, as well as being able to accept underlying ideal price data for Trade Orders. Put another way, orders that an automated trading tool intends to send to the exchange, which fall outside of exchange defined price and quantity boundaries or increments, may be sent to the Order Book Manager using their ideal price and quantity levels in place of, or in addition to, the values that will ultimately be sent when the Trade Order is sent to the exchange.

It is important to note that the embodiments described herein have assembled data in OrderBook Repository 140 without relying on data produced by Exchange Market Data Feed 111. Particularly important is that neither Modeled Engine 360 or Modeled Market Server 380 are consuming data from, or derived from, Exchange Market Data Feed 111.

While the previous depiction of Non-Trade Orders and Trade Orders, as well as their underlying or ideal price information, has been within the context of OrderBook Repository 140, it should be noted that such handling may also be provided within Exchange 108.

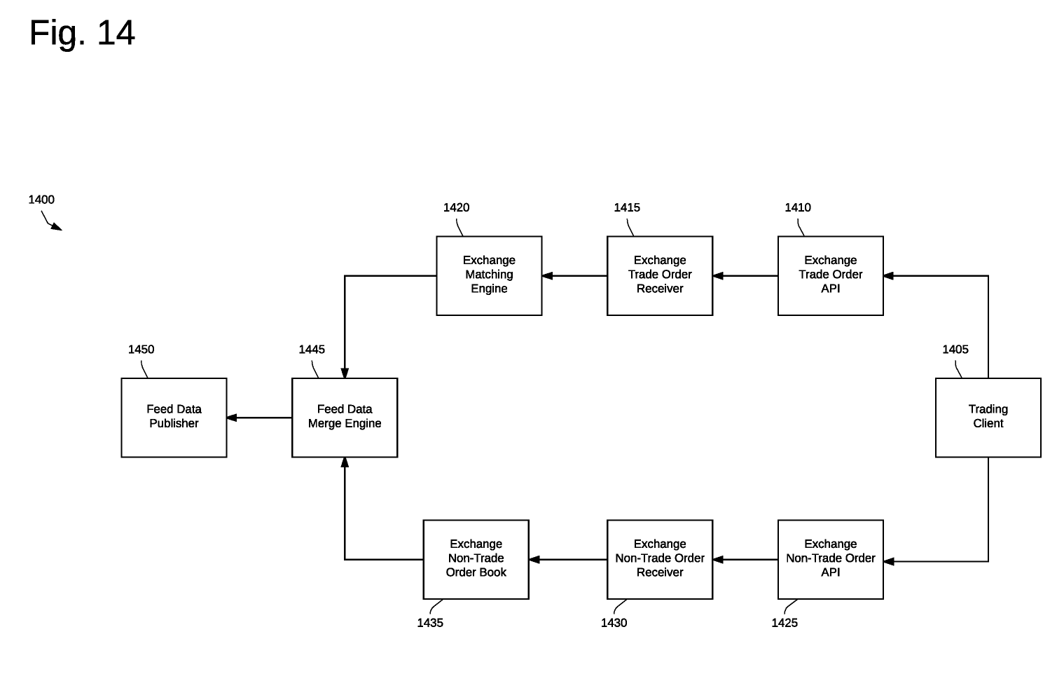

FIG. 14 illustrates a flow diagram of an example implementation of handling Non-Trade Orders as well as Trade Orders, with their underlying or ideal price information, within an exchange such as Exchange 108. This is in contrast to, and an alternative to, previously described ISV-based approaches.

In FIG. 14 we see that Trading Client 1405, which may be an automated trading tool or include automated trading tools, is able to provide both Trade Orders and Non-Trade Orders to an exchange, such as Exchange 108, via endpoints or APIs, such as those described in blocks 1410 and 1425.

Block 1410 represents an API or endpoint within an exchange that accepts Trade Orders from Trading Client 1405. Upon receipt of Trade Orders, execution moves to block 1415 where order parameters are validated and other internal bookkeeping tasks of the exchange occur. If the order is valid and accepted it will be sent to the exchange's matching engine in block 1420 where it is eligible for matching. As the matching engine goes through cycles of matching it will produce market data that is destined to be sent to market data subscribers. Before reaching Market Data Publisher 1450 this data will first go through Feed Data Merge Engine 1445.

Returning back to Trading Client 1405, when Non-Trade Orders are sent to the exchange they are directed towards block 1425. After the Non-Trade Orders are received their order data is passed to block 1430 where they are checked for validity and exchange housekeeping occurs. In this case, in contrast to block 1415, the data for the Non-Trade Orders may not be required to conform to exchange defined price increments or other parameter restrictions defined for the tradable object in question. An example of this would be for a tradable object with a defined tick increment of 0.25, where a Trade Order would be required by the exchange to be priced on a multiple of that increment, such as 100.75, while a Non-Trade Order processed in block 1430 would not have the requirement and could be priced at a level such as 100.68073.

Control moves on to block 1435 where the Non-Trade Order is stored in an order book dedicated to Non-Trade Orders. Upon insertion into the order book, or on a time interval or other event, the book data is provided to Feed Data Merge Engine, block 1445.

At block 1445 the Feed Data Merge Engine does the job of bringing together the marked feed data for Trade Orders with that of the Non-Trade Orders. An interesting note here is that there is a combining of data from Trade Orders which exist on price level (i.e., tick) boundaries, and the data from the Non-Trade Orders which may not. In order to facilitate this, at block 1445, or at previous blocks, the orders stored in the Non-Trade Orders order book are augmented with a price-level value that represents the nearest price-level increment away from the inside market. Put another way, based on the ideal price of the Non-Trade Order, an on-tick price is calculated that is away from the inside market. An example of this would be a Non-Trade Order representing a buy at 100.68073 would be augmented with an on-tick price-level value of 100.50. This information is used in block 1445 to indicate which on-tick price-levels the Non-Trade Orders should be associated with for purposes of GUI display or other on-tick price-level based display or reporting. It should be noted that the on-tick augmented prices may also be calculated by rounding towards the inside market or nearest value.

When merging Non-Trade Orders in with Trade-Orders, additional flags may be added to the resulting market data to indicate that the included data associated with Non-Trade Orders is non-tradable. These flags may be stored within the market data feed and provide the data subscriber with the ability to identify the market data elements that contain non-tradable values. In a market data feed such as CME's Market By Price feed, there can be a loss of actionable information as the by-price aspect of the data feed would combine both Trade Order and Non-Trade Order into data that is aggregated per price level. While not required, a more useful arrangement of providing Non-Trade Order data in a market data feed would be to distribute the data within a feed such as CME's Market By Order (MBO) format, as it allows for each order within a price level to be distinctly communicated. In addition to including augmented price-level data, including Non-Trade Order data within an MBO feed may require adding a data annotation to each order in the data feed to indicate if it is a Non-Trade Order. This may be accomplished by the addition of a flag or by utilizing a specific value, such as −1 or 0, within the existing priority field of MBO.

Returning to block 1445, upon completion of the merge control moves to 1450 where the market data feed is published out to subscribers.

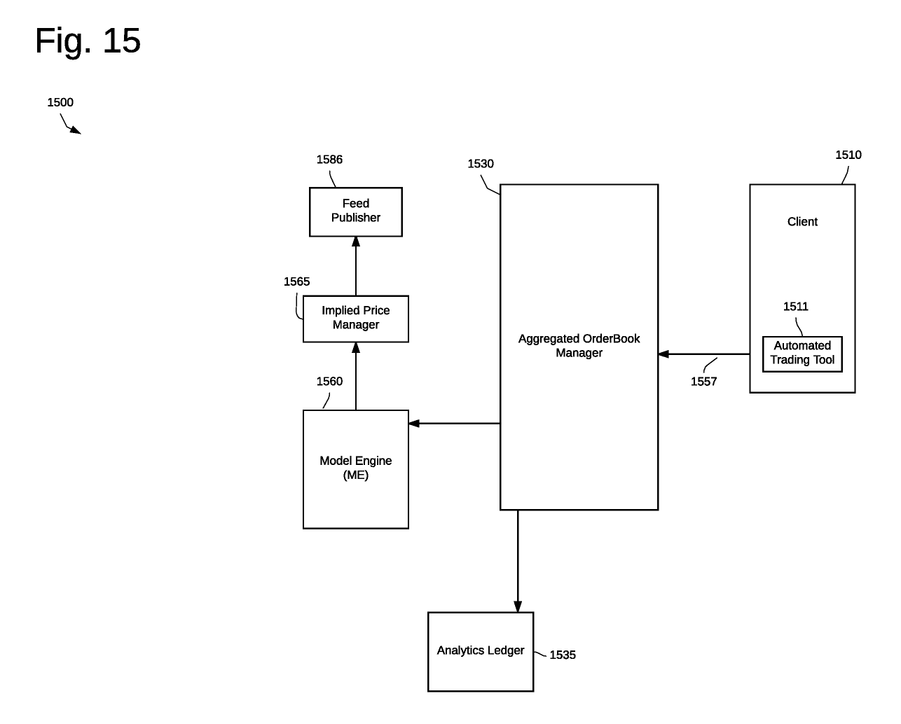

FIG. 15 describes an example implementation where Client 1510 does not distribute orders to Exchange 108, and instead only distributes order actions to the aggregated view of customer orders, Aggregated Order Book (AOB) 1530.

In this example, AOB 1530 collects customer initiated order actions as well as the related customer initiated order action updates and creates an aggregated order book representing the most up-to-date view of orders.

This mechanism of providing customer initiated order actions to AOB 1530 is especially useful when those customer initiated orders are solely comprised of Non-Trade Orders. Such an arrangement would allow for the capture and modeling of data from Non-Trade Order sources such as automated trading tools. This data represents an untapped view of potential market activity.

Client 1510 may provide a unique identifier with every event to AOB 1530 that allows for identification of the tradable object for which events are being sent. This allows Client 1510 to maintain a non-changing tag when communicating to AOB 1530. Alternatively, AOB 1530 may provide a mechanism to centralize identification of unique tradable objects, returning them to Client 1510 on-demand.

Client 1510 may be any device or component that prepares or sends Non-Trade Orders. Client 1510, optionally via Automated Trading Tool 1511, will generate, modify, delete, and otherwise manipulate Non-Trade Orders. These updates to Non-Trade Orders are sent to AOB 1530 via message 1557. It is important to note that these updates are not sent to an exchange. Additionally, Non-Trade Orders are tagged as Non-Trade Orders within either Client 1510 or AOB 1530 so that throughout the system they can be identified as Non-Trade Orders.

Model Engine 1560 is responsible for combining the order information and updates into a modeled view of the market using only Non-Trade Order updates. Model Engine 1560 may use techniques such as combining order data at similar prices and bid-ask side, removing orders from the modeled view that are contra-side and would cross, creating approximations of price levels that orders fill at, etc. Additionally or alternatively the customer order data feed into Model Engine 1560 may be fed into a matching engine in order to provide a simulated market.

Implied Price Manager 1565 is positioned within the system to allow for optionally enabled calculation of implied prices, which would be injected into the dataset generated after Model Engine 1560. Following the optional injection of implied prices, Feed Publisher 1586 is responsible for sending the resulting market data feed to interested subscribers.

We claim:

1. A method for generating a client-action based modeled market while not consuming market data from an exchange, the method comprising:
detecting client orders;
receiving order confirmation notifications;
receiving order updates;
detecting subsequent order actions;
combining order actions, confirmations, updates, and subsequent order actions into an aggregated order book;
notifying a modeled market engine with updated aggregated orderbook data;
creating a modeled market based on combined aggregated orderbook data;
sending modeled market data to a feed distributor; and
communicating modeled market data to client feed consumers.

2. The method of claim 1 where client orders are received;

3. The method of claim 1 where subsequent orders actions are received;

4. The method of claim 1 where client orders, notifications, updates, and actions are combined from one or more clients

5. The method of claim 1 where the client orders further comprise subsequent order actions.

6. The method of claim 1 where the client orders comprise client initiated orders.

7. The method of claim 1 where the client orders further comprise subsequent client initiated order actions.

8. The method of claim 1 where the client orders and actions are processed in an aggregated order book prior to communication of those orders and actions to an external system.

9. The method of claim 1 where order confirmation notifications are received via and external system.

10. The method of claim 1 where order confirmation notifications are pre-emptively combined into the aggregated order book prior to external confirmation notification.

11. The method of claim 1 where order confirmation notifications are initiated by the trading client.

12. The method of claim 1 where order confirmation notifications are comprised of order updates or actions.

13. The method of claim 1 where order confirmation notifications are further comprised of fill notifications from an external system.

14. The method of claim 1 where the modeled market engine receives updates from multiple clients.

15. The method of claim 1 where the modeled market engine receives updates comprised of data from multiple orderbooks.

16. The method of claim 1 where updates to the modeled market engine are comprised of new orders, cancellation of orders, and updates to the status orders.

17. The method of claim 1 where the modeled market is updated and modified when combined orderbook data is received.

18. The method of claim 1 where the modeled market is further modeled based on parameterized customizations.

19. The method of claim 1 where the modeled market is adjusted prior to being sent to the feed distributor, based on parameterized customizations.

20. The method of claim 1 where the result of an implied price calculation is injected into the modeled market data prior to sending the modeled market data to a feed distributor.
